(19) United States
(12) Patent Application Publication
(10) Pub. No.: US 2015/0186427 A1
(43) Pub. Date: Jul. 2, 2015

(54) METHOD AND SYSTEM OF ANALYZING DYNAMIC GRAPHS

(71) Applicant: Telefonica Digital Espana, S.L.U., Madrid (ES)

(72) Inventors: Dionysios LOGOTHETIS, Madrid (ES); Georgios SIGANOS, Madrid (ES)

(73) Assignee: Telefonica Digital Espana, S.L.U., Madrid (ES)

(21) Appl. No.: 14/141,130

(22) Filed: Dec. 26, 2013

(51) Int. Cl. G06F 17/30

(52) U.S. Cl. CPC G06F 17/30277

(57) ABSTRACT

A method and a system for analyzing dynamic graphs are disclosed. In accordance with such method and system, computations are performed at a plurality of graph vertices every time a change in the graph occurs. In order to minimize the computational load of each computation iteration, previous computation results are reused when the inputs for a computation at a given vertex are unchanged from previous computations. This approach enables real-time data mining from large dynamic graphs, without requiring users to devise their own incremental graph algorithms.

### FIELD OF THE INVENTION

The present invention has its application within the information retrieval sector, and specifically, in the area dedicated to data mining from dynamic graphs.

### BACKGROUND OF THE INVENTION

In the past years, there has been an increasing interest in the information retrieval sector for developing data mining applications capable of extracting information from data structures in the form of large graphs of interconnected elements. For instance, this is the case of social networks sites, which require analyzing the graph structure of the network in order to provide customized information to each user, such as recommending new contacts or including targeted advertising. In this scenario, each user of the network is a vertex of the graph, whereas each connection between two users is an edge between two vertices.

For example, US 2011/0283205 A1 presents a method and system to build and visualize a bidimensional graph which combines information about users relationships and interactions from a plurality of web pages. Edges of the graph are given weights depending on the strength of the connections between users. In yet another example, US 2013/0031171 A1 discloses an application which builds a social network graph by combining information from other social networks, the graph edges representing the nature of the relationship between two users.

Once the network graph is constructed, data mining algorithms can be applied to analyze the network or provide customized content and recommendations for each user according to the graph connections. For example, US 2013/0275429 A1 discloses a system for contextual recommendation, in which information about documents and objects being used by a user is applied to a social network graph database in order to recommend relevant objects and people.

However, there are several challenging factors to consider when developing data mining algorithms for this kind of scenarios. Firstly, in many cases the number of vertices and edges of the graph are very large, therefore generating a very large sheer volume of the input data. Secondly, the graph is being constantly modified, requiring to continuously run the data mining algorithm in order to update its output. Notice that in a large social network, these changes can be in the order of thousands of changes per minute. Finally, graph mining algorithms are usually complex and require a large number of computation iterations before providing a final output. The combination of these three factors result in a huge computational load, that often makes it impossible to provide real-time data mining of large dynamic graphs with systems currently existing in the state of the art.

Moreover, given the complexity of the problem, most existing data mining applications only aim towards static graph analysis. This is the case of Pregel, a proprietary system developed by Google, and Apache Giraph, an open source implementation of Pregel. These systems offer a flexible programming interface that allows users to develop a variety of graph mining algorithms. Furthermore, they also allow the parallel execution of said algorithms on large clusters of machines. The algorithm execution is divided in a number of iterative steps, said steps being computed in parallel in the vertices. In Pregel-based systems, vertices interact with each other through message passing. Similar alternatives based on vertices communication through a shared memory are also known. Nevertheless, all these systems are designed towards the analysis of static graphs. When dynamic graphs are tackled, these systems require to re-run the entire data mining algorithm for each change in the graph, resulting in an extremely high computational load that is too demanding for most application scenarios.

Other alternatives, such as Kineograph, provide support for dynamic graph analysis. However, these platforms require the user to devise their own dynamic algorithms, therefore relying exclusively on the user's programming skills. Given the difficulty of programming efficient customized algorithms even for simple tasks such as computing shortest distances in a large graph, the complexity of this approach is typically prohibitive. Even if dynamic algorithms are devised on these platforms, their computational load is generally not optimized enough for being viably applied in large graphs.

Given the aforementioned limitations of the graph mining tools known in the state of the art, there is a need for a method and system of analyzing large dynamic graphs in an efficient and stable manner with a limited computational load.

### SUMMARY OF THE INVENTION

The current invention solves the aforementioned problems by disclosing a method, system and computer program of data mining in dynamic graphs, that minimizes computational load of an iterative algorithm by re-using previous computations whenever possible. By applying high-granularity memoization techniques, latency is greatly reduced, enabling real-time operation.

In a first aspect of the present invention, a method of analyzing dynamic graphs is disclosed. The goal of the method is to obtain a constantly updated output of an algorithm for a plurality of vertices comprised in the dynamic graph, being the algorithm executed by means of iterative computations performed in parallel in the plurality of vertices. Whenever a change occurs and modifies the graph, such as an addition of a vertex or an edge between vertices, the algorithm is re-executed to update the output. Computations inputs for a first graph state before the change and a second graph state after the change are compared to determine which vertices are candidates for memoization.

In order to minimize computational load when re-executing the algorithm for the second graph state, for each iteration of the algorithm computations, vertices are classified into two groups:
A first group, whose computations are affected by the graph change, that is, those vertices for which the computation inputs in the second graph state are different from the computation inputs in the first graph. The computation results of vertices of the first group are updated by executing again the algorithm computation. Preferably, the first group comprises all the vertices which verify that least one of the following inputs is modified by the change in the graph: vertex state, graph topology surrounding the vertex and information received from adjacent vertices.
A second group, whose computations are not affected by the graph change and are therefore candidates for memoization. Since computations are deterministic, the second group comprises any vertex at which the computation inputs are identical in the first graph state and the second graph state. For the vertices belonging to the second group, computations are avoided and their computation results are updated by using previously computed results. With this approach, computational load and algorithm latency is greatly reduced, enabling the analysis of large dynamic graphs.

Both computation results and computation inputs are stored by the method in order to being able to compare the computations of graph states before and after the change, and determine which vertices can be memoized.

Preferably, the method comprises distributing vertices in a plurality of partitions, enabling to efficiently handle large graphs. Each partition comprises at least a compute state which stores the computation results of all the vertices handled by the partition. Preferably, the partitions have a limited size, measured in the number of edges between vertices managed by the partition. Also preferably, the partition comprises routing information in order to efficiently communicate vertices of the partition with vertices belonging to a separate partition.

Global aggregators provide global statistics which can be accessed by all the vertices. Preferably, in order to maintain the advantages of incremental processing, each partition comprises an aggregate state which stores a contribution of the vertices of the partition to the global aggregator.

In another preferred options, partitioning is dynamically updated, and vertices are redistributed in the partitions according to factors such as graph topology and partition computational load. Preferably, the method runs a plurality of data mining applications in parallel, each application comprising an algorithm which is applied to the vertices of the graph. Partitions manage the parallel execution of multiple algorithms by comprising an independent compute state for each algorithm, while sharing the information about graph topology and graph changes.

Also preferably, several changes are analyzed simultaneously to minimize latency. Any state of the graph can be expressed as a base state and a set of changes. The output of the analysis for a given graph state is obtained by applying to the output of the base state the computation results associated to each change of the set. To ensure analysis consistency, the results of executing the computations associated to each change are stored with a monotonically increasing identifier which labels said change. When a change is fully analyzed, the method preferably updates the base graph and its output with the graph and results associated to the fully analyzed change, and removes previous stored results. In yet another preferred option, the method of the invention groups and schedules graph changes before their analysis in order to optimize latency.

Vertices of the graph preferably communicate with each other through messages, as in Pregel-based systems. Nevertheless, in other preferred embodiments of the method, vertices communicate through a shared memory. In case a message was sent in a previous execution of the algorithm, but is not sent as a consequence of the graph change, this situation is preferably notified to the vertex that received the message in the previous execution of the algorithm.

In a second aspect of the present invention, a system of analyzing a dynamic graph is disclosed. The system comprises graph processing means adapted to update a computation result at each vertex of the graph according to a graph analysis algorithm. The algorithm is executed by means of iterative and distributed computations after each graph change, using memoization means to determine which vertices can re-use results from previous computations. Memoization is achieved by comparing computation inputs for each vertex and each operation for two graph states: a first graph state before the change and a second graph state after the change. When computation inputs for a given vertex and iteration in both graph state is the same, re-execution of the computations is prevented, and the computation results obtained in previous executions are used instead. Computational load and latency are therefore greatly reduced, enabling real-time operation in large dynamic networks.

The graph processing means and memoization means are preferably distributed in a plurality of partitions, each partition handling a plurality of vertices. Furthermore, the system preferably comprises dynamic graph management means adapted to overlap the computations corresponding to multiple changes, therefore reducing latency. An scheduler is preferably integrated in the system to group and schedule graph changes.

In a third aspect of the present invention, a computer program is disclosed, comprising computer program code means adapted to perform of the described method when said program is run on a computer, a digital signal processor, a field-programmable gate array, an application-specific integrated circuit, a micro-processor, a micro-controller, or any other form of programmable hardware. Note that particular embodiments and options of the method of the invention can also be applied to particular embodiments of the system and computer program of the invention.

With the disclosed method, system, and computer program, real-time analysis of large dynamic graphs with reduced latency and computational load is enabled. The dynamic analysis builds upon an algorithm for static graph analysis, and uses memoization to speed up re-executions of the algorithm. With this approach, the need of devising complex dynamic algorithms is circumvented. These and other advantages will be apparent in the light of the detailed description of the invention.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows an example of a graph comprising a plurality of vertices and edges.

FIG. 2 exemplifies an execution of a graph analysis application through iterative computations at each vertex.

FIG. 3 shows the re-execution of the same graph analysis application after the graph properties are modified.

FIG. 4 presents a scheme of the partition structure according to a particular embodiment of the present invention.

FIG. 5 schematically depicts the elements involved in graph change scheduling according to a particular embodiment of the present invention, as well as several external services included in particular embodiments of the present invention.

FIG. 6 presents a flow diagram of a particular embodiment of the method of the invention.

FIG. 7 shows the modules comprised in a particular embodiment of the system of the invention.

### DETAILED DESCRIPTION OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

Note that in this text, the term “comprises” and its derivations (such as “comprising”, etc.) should not be understood in an excluding sense, that is, these terms should not be interpreted as excluding the possibility that what is described and defined may include further elements, steps, etc.

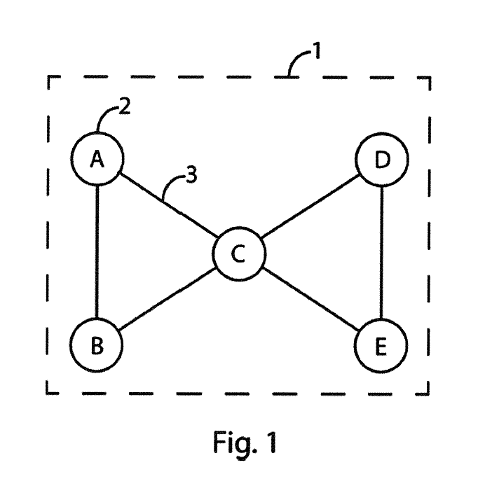

FIG. 1 shows a simple example of a dynamic graph 1 from which data needs to be mined. The graph 1 comprises a plurality of interconnected nodes, called vertices 2. Each connection between two vertices 2 is called an edge 3. In the computation model of the method and system of the invention, each vertex 2 is an independent unit containing its own state. Data mining algorithms are executed as iterative computations run in parallel on each vertex.

In particular embodiments of the invention, the computation model is built upon known distributed graph abstraction such as Pregel and Graphlab by using data mining algorithms devised with these programming models. These models provide flexible and simple programming tools that support distributed processing and scale to large graphs. Furthermore, they naturally break down the execution of an algorithm into sub-computations, allowing the method and system of the invention to identify opportunities for computation re-use. Nevertheless, note that any other distributed programming model can be used to devise the data mining algorithm. Also note that in the preferred embodiments that follow, vertices 2 communicate with each other through message passing, as in Pregel-based systems. However, any alternative vertices communication schemes can be used in particular embodiments of the invention, such as accessing a shared memory.

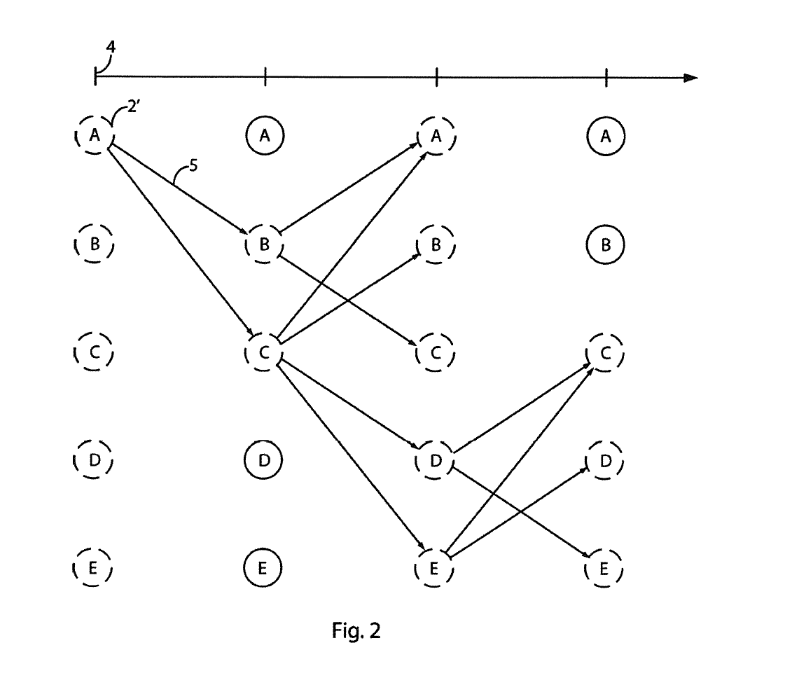

FIG. 2 illustrates the execution of a data mining algorithm in the graph 1. The algorithm is devised for analyzing a static graph, and provides the starting information that the method and system of the invention then updates in real time when changes in the graph 1 occur. The algorithm is executed by performing parallel computations in the vertices 2 in an iterative manner. As an example, we consider a single-source shortest path (SSSP) algorithm in which every vertex 2 maintains as states its current distance to the source node A. In each iteration, if the current computed distance decreases, it is communicated to adjacent vertices 2 through messages 5. The algorithm terminates when there are no messages and all vertices 2 have voted to halt, that is, when all vertices 2 have reached stable states. Each iteration of the algorithm computations among the vertices 2 is called a superstep 4. At each superstep 4, only vertices 2 whose states have been modified and vertices 2 which have received a message 5 need to perform the computations of the algorithm. This first group of vertices that need to perform the computations 2′ at a superstep 4 are represented by dashed circles. In this particular example, in the first superstep 4, node A sends messages 5 to adjacent nodes A and B, which update their states and propagate the information through messaging in subsequent supersteps 4 until the final results are obtained.

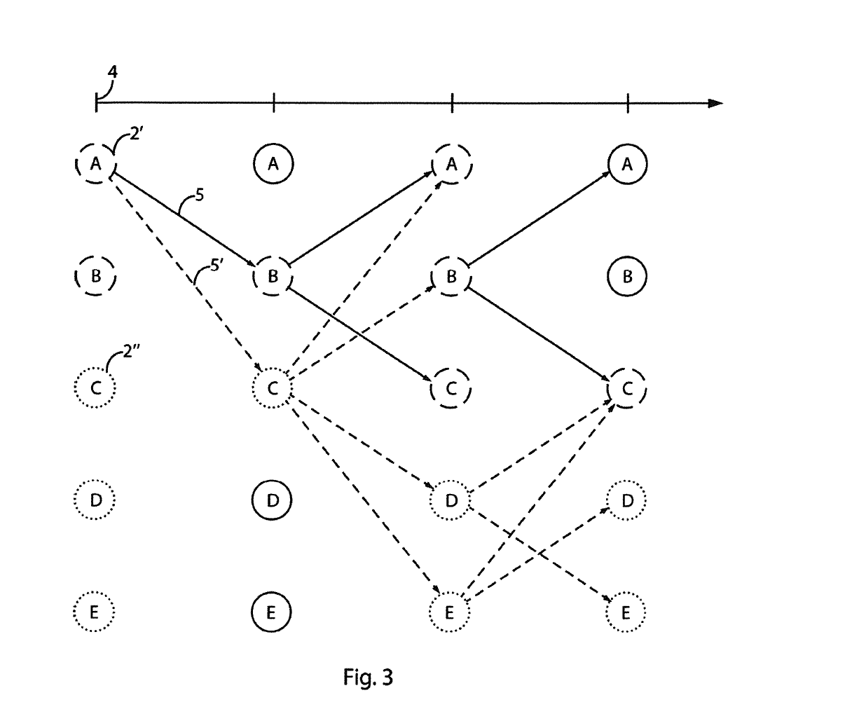

FIG. 3 illustrates the execution of the same algorithm when a change occurs in the graph 1. In this particular example, the distance between node A and node B increases, but any other change in the nodes state or in their topology could be analyzed in an equivalent manner. Techniques known in the state of the art require to perform again all the computations of the algorithm, disregarding all the computations performed in previous executions of the algorithm. According to the method and system of the present invention, memoization is applied to avoid repeating calculations and speed up the algorithm execution. Computations that are identical to computations previously performed are detected, and instead of being re-run, the result of the previously performed computations are used. Likewise, messages that are identical to messages previously sent are detected, and their transmission is prevented. Identical messages 5′ whose transmission is prevented are represented as dashed lines in the figure.

Therefore, two separate groups of vertices 2 are selected at each superstep 4: the first group of vertices 2′ that need to perform computations due to changes in their computations compared to previous executions of the algorithm, and a second group of vertices 2″ that do not need to perform computations since identical computations were previously performed. The second group of vertices 2″ is represented in the figure by dotted circles. In order to determine whether a vertex 2 belongs to the first group of vertices 2′ or the second group of vertices 2″, computation inputs for each vertex 2 at each superstep 4 are compared for two distinct graph states, a first graph state before the graph change, and a second graph state after the graph change.

Accordingly, at each superstep 4, the first group of vertices 2′ perform the computations of the algorithm, whereas the second group of vertices 2″ simply updates their states with the results of previous computations. In practice, only a small fraction of new computations are necessary to get a consistent updated result when a change occurs, greatly reducing computational load and enabling real time operation.

A dependency graph is maintained among computations in order to determine which vertices 2 belong to the second group of vertices 2″ and which messages 5 are identical messages 5′. The dependency graph comprises information regarding which vertices 2 are affected by changes in other vertices 2 in each superstep 4. To ensure re-executing a minimum number of computations, dependencies are kept track at a high granularity. Specifically, computations are memoized at the granularity of individual messages 5 and individual vertices 2. That is, the dependencies of each vertex 2 are individually analyzed in order to determine if their computations need to be executed, and the dependencies of each message 5 are individually analyzed in order to determine if they need to be sent. To ensure that computations can be safely re-used, said computations must be deterministic and depend only on input messages 5 and vertices 2 states.

When a change in the graph 1 occurs, the execution of the algorithm proceeds in two phases. In the first phase, the first group of vertices 2′, that is, vertices which are affected by the change are selected and labelled. An affected vertex is a candidate for re-computation since the computation result may be modified by the graph change. Graph changes can include changes in a vertex property, vertex additions and deletions, edge additions and deletions and changes in an edge property. After being selected and labelled, computations are executed for the affected vertices, that is, for graphs of the first group 2′.

After that, at every subsequent superstep 4, computations for a vertex 2 are only performed if at least one of the following computation inputs are modified:
The vertex 2 receives at least a message 5 which is different than in previous executions of the algorithm.
The vertex 2 presents a different compute state than in previous executions of the algorithm.
The graph structure around vertex 2 is different than in previous executions of the algorithm. That is, the topology of the nearby vertices 2 and edges 3 connected to said vertex 2 is modified.

It is possible that when re-executing computations, a vertex 2 generates less messages 5 than said vertex 2 generated in previous executions of the algorithm. Vertices 2 which originally received said messages 5 and do not receive it anymore are therefore notified. To handle this case, for every computation, a list of destination vertices 2 is memoized. If this list contains a vertex 2 that should no longer receive a message, a special ‘remove’ message is sent.

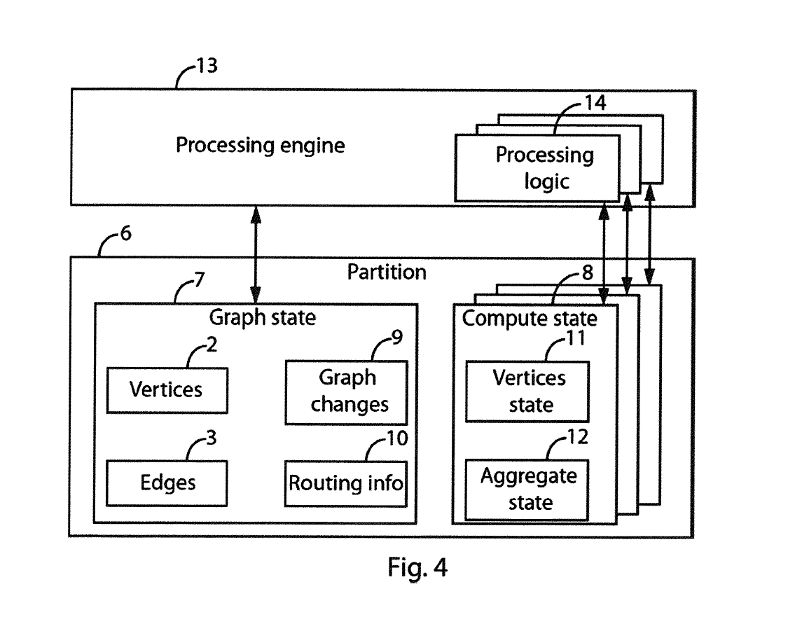

In order for the system and method of the invention to be scalable, a flexible and lightweight graph distribution mechanism is implemented. The graph 1 is divided into a plurality of partitions 6, whose main components are shown in FIG. 4. Each partition 6 manages a plurality of vertices 2. The number of partitions 6 is preferably significantly larger than the number of available processing engines 13. Processing engines 13 can be independent machines or computing threads. Partitions 6 are agnostic to the partitioning algorithm, and any partitioning algorithm known in the state of the art can therefore be used. As a preferred approach to achieve fair load balancing and avoid hotspots, partitions are randomly distributed across the available processing engines 13. Note that this partitioning can be modified and balanced during operation with minimum cost by leveraging the granularity of the partitioning.

Each partition 6 comprises all the resources needed to process the computations of vertices 2 of said partition 6 and to route any message 5 without contacting any external service for routing information. The partition therefore comprises a graph state 7 comprising information of the vertices 2 and edges 3 managed by said partition, as well as a list of graph changes 9. A partition 6 has preferably a standard capacity, typically measured in the number of edges 3 said partition manages. The partition 6 preferably contain a group of vertices 2 that are adjacent or close by. A graph state 7 of a partition 6 also holds routing information 10 in order to route messages 5 directed towards vertices 2 of other partitions 6. A partition 6 also comprises a compute state 8, said compute state further comprising the serialized vertices state 11 optimized for fast reading and writing to disk and an aggregate state 12 for incrementally computing global aggregators.

Partitions 6 are connected with a processing engine 13, said processing engine comprising the processing logic 14 required to perform the computations of the algorithm. Several algorithms can be executed in parallel at the same graph 1 by several applications. In that case, the processing engine 13 comprises independent processing logic 14 for each algorithm, and the partition 6 comprises an independent compute state 8 for each algorithm. This allows different policies regarding caching, batching sizes, etc. Graph state 7 is shared by all the applications. To resolve the location of the partitions 6, a small cache per server is utilized to play the role of a routing component. The amount of information required for this routing is proportional to the number of partitions 6, instead of being proportional to the number of vertices 2 as it is the case in vertex-based routing.

Global aggregators are provided in particular embodiments of the method and system of the invention in order to maintain global statistics about the graph 1 and to coordinate execution amongst vertices 2. During a superstep 4, each vertex 2 can add a value to a global aggregator. The aggregated value is then available for all vertices 2 to read in the next superstep. A change in the computation of a single vertex 2 can therefore impact the value of the global aggregator. In order to maintain the advantages obtained through memoization, the values of the aggregator are computed incrementally. Each partition 6 holds in its compute state 8 an aggregate state 12 which stores a partial aggregator representing the effect on the global aggregator of the vertices 2 and computations of said partition 6. This enables re-using partial aggregators when unmodified by the re-execution of the algorithm. The aggregate state 12 is typically small (e.g. a single value per partition 6), preventing unnecessary accesses to the entire partition 6 from disk.

Note that this approach still requires re-computation of the entire aggregate state 12 of a partition 6 even if only a single vertex 2 is modified. To address this issue, the incremental computation of the aggregators is more finely grained in particular embodiments of the invention. For aggregator functions that are subtractable, per vertex 2 partial aggregator values are held. When a vertex 2 re-computes, the old partial value is substracted and the re-computed one is added, maintaining a correct global aggregate with minimum re-computation. Also note that additional custom aggregator functions can also be added with independent aggregator APIs in particular embodiments of the invention.

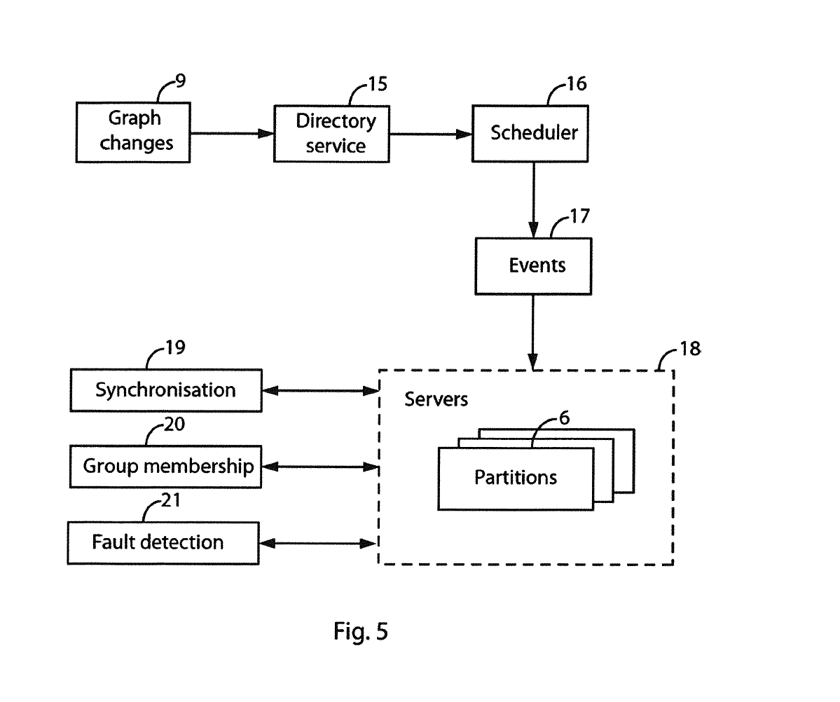

FIG. 5 presents the main elements involved in graph change scheduling, as well as some external services provided to the graph analyzing system. In particular, graph changes 9 (also called mutations) are first forwarded towards a directory service 15 that maps the vertices 2 of the graph change 9 to their corresponding partition 6. Subsequently, graph changes 9 are forwarded to a scheduler 16. The scheduler 16 is responsible for limiting the rate of graph changes 9 notified to the partitions 6, as well as grouping together graph changes 9 and adjusting resources to adapt to the current load. Graph changes 9 are therefore grouped and scheduled in events 17, which are communicated to the servers 18 managing the partitions 6 that are affected by said events 17. External services provided to the partitions 6 may include synchronization means 19, group membership management means 20 and fault detection means 21.

Regarding the grouping of graph changes 9 into events 17, several strategies can be implemented. For example, in a particular embodiment of the invention, a configurable maximum delay is enforced, and graph changes 9 are grouped in events 17 according to the partition 6 to which said graph changes 9 belong. Since the graph changes 9 affect the same neighborhood of vertices 2, they can be bulk-processed as a single event 17. Nevertheless, alternative approaches can be implemented in different embodiments of the invention. In order to provide consistency, pipelining and elasticity, events 17 are assigned a unique monotonically increasing identifier that is then stored in the graph state 7 of the affected partitions 6.

Since the dynamic graph 1 to which the method and system of the invention are applied is typically in constant change, it must be guaranteed that the algorithm is executed on a consistent version of the graph 1, and that the effects of all the graph changes 9 are processed in order. In a conventional approach, graph changes 9 are queued and managed individually, waiting for all computations related to a given graph change 9 to be finalized before starting with the computations related to the next graph change 9. However, this approach greatly increases processing latency. This issue is even more critical when different applications with disparate rates are applied to the same graph 1, since all the applications must wait for the slowest application to be over before analyzing the next event 17.

Instead, the method and system of the invention enable the underlying graph 1 to change while algorithm execution is in progress. To achieve this, multiple versioned graph states are stored, that is, the topology and vertices states after each graph change 9 are indexed and stored. These graph states (also called snapshots in this description) are stored at a partition level, and the event 17 identifiers added by the scheduler 16 are used for indexing. Therefore, algorithm execution on a consistent snapshot is guaranteed. All the computations and messages 5 therefore occur in the context of a specific event 17 identifier. Messages 5 between vertices 2 carry the identifier of the event 17 they correspond to. This is used as input in the receiving vertex 2 to use the correct version of said receiving vertex 2. Computation results are also labelled with the event 17 identifier.

Internally, each vertex 2 is maintained as base vertex accompanied by an ordered set of versioned changes. A specific version is reconstructed by applying all the changes to the base vertex up to its required version. This avoids the overhead of creating and storing full replicas of a vertex for each version. The graph representation is periodically compacted by permanently applying to each base vertex all the changes that have already been fully processed. Said changes are then discarded. In a preferred embodiment of the invention, vertex changes occur on a per application basis and are not visible to other applications. Vertex changes are therefore independently stored in the vertices state 11 of each compute state 8 of the partition 6. Nevertheless, alternative strategies for storing the ordered set of changes can be implemented in alternative embodiments of the invention.

Concurrent processing of multiple events 17 is enabled. Specifically, the execution of an event 17 can be processed before the execution of a previous event 17 is concluded. Thanks to the storing of multiple consistent graph snapshots and to processing in the context of a specific event, it is guaranteed that the final output is exactly the same as if the events 17 where processed one at a time. For correctness, it is guaranteed that if the computations of an event i is currently at a superstep S, the computations of event i+1 are at most at superstep S−1. This synchronization is implemented on a partition 6 basis without any expensive global synchronization.

The described method and system greatly optimize computational load. For example, for typical workloads of a social network and typical algorithms such as calculating shortest paths or finding closing triangles (useful for friend recommendation), the described method and system can save up to 99% and 95% of the computations respectively.

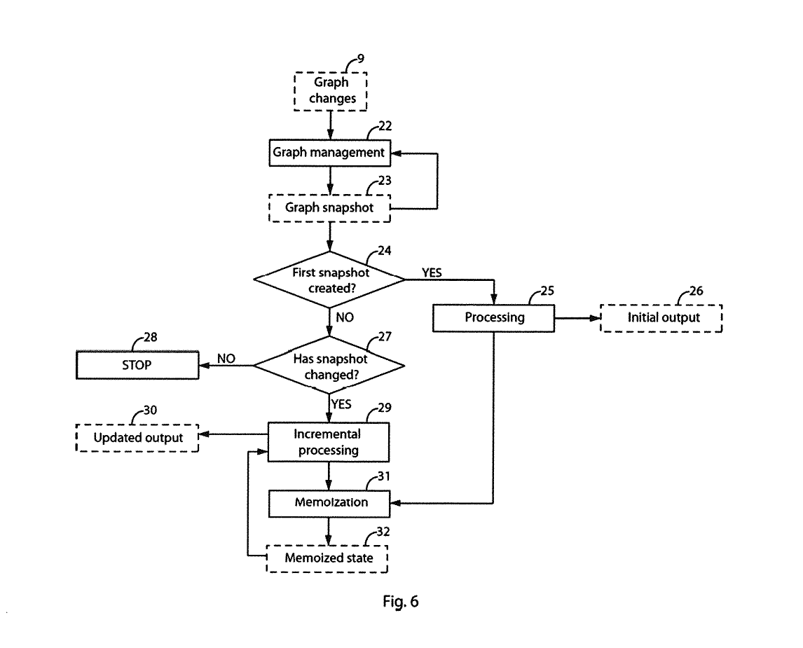

FIG. 6 presents a flow diagram of the main processes performed by a preferred embodiment of the method of the invention. Solid-line squares represent processes, dashed-line squares represent inputs and outputs and diamonds represent decisions and condition verifications. The input of the processes is a graph change 9. Note that the first time the algorithm is applied to the graph 1, the input is the initial state of said graph 1. Both the initial state of the graph and any subsequent graph changes 9 are handled by a graph management 22 process that stores the initial state of the graph 1 and generates snapshots 23, which represent modified versions of the original graph 1 as affected by graph changes 9. Graph management 22 process keeps updating the graph snapshot 23 whenever additional graph changes 9 occur.

Then, it is checked 24 if the graph snapshot 23 under analysis is the first snapshot created for the graph 1. If it is the first graph snapshot 23, then processing 25 is applied, executing a data mining algorithm for a static graph and providing initial output 26. Furthermore, memoization 31 is applied to the results of processing 23 in order to obtain a memoized state 32 that will be applied for reducing computational load in subsequent iterations of the algorithm. Otherwise, if the graph snapshot 23 is not the first, then it is verified 27 if the graph snapshot 23 has changed from the last execution of the algorithm. If the graph snapshot 23 has not changed, then the process stops 28 until further graph changes 9 occur. If the graph snapshot has changed 29, incremental processing 29 is applied to generate an updated output 30. Incremental processing 29 applies the memoized state 32 in order to minimize computational load. The results of incremental processing 29 also undergo memoization 31 in order to update the memoized state 32. Therefore, the incremental processing 29 reads the memoized state 32, but also updates said memoized state 32 at the end to reflect the new state of the graph 1.

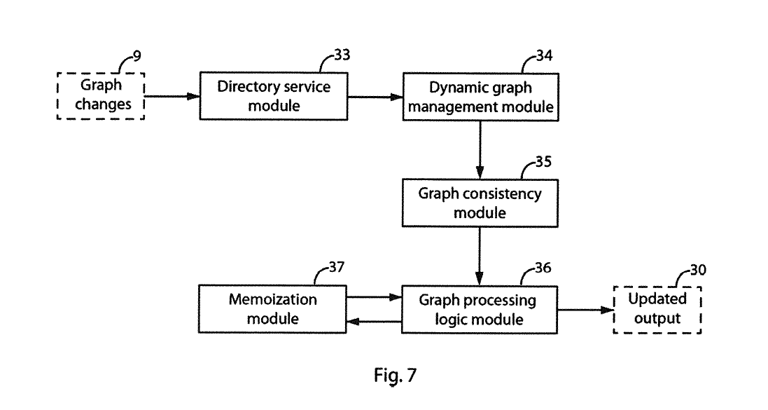

FIG. 7 shows the modules involved in a particular embodiment of the system of the invention, said modules executing a particular embodiment of the method of the invention. The system comprises a directory service module 33 that receives as input graph changes 9 and routes said changes to the affected partitions 6. For scalability, partitions can be distributed across a plurality of machines, therefore requiring the directory service module 33 to route the graph changes 9 notifications to the machines and partitions whose vertices 2 are affected by the graph changes 9.

Graph changes 9 are handled by a dynamic graph management module 34. The dynamic graph management module 34 maintains the graph 1 in a distributed manner across the partitions 6, and updates the graph layout at those partitions 6 as said layout evolves over time. The dynamic graph management module 34 also stores the graph 1 layout data structure in memory in a space-efficient manner, enabling fast access to the stored data structure. When graph changes 9 occur, the dynamic graph management module 34 updates the stored data structure. The graph 1 layout data structure is either implemented in an internal memory or in an external unit or disk depending on particular embodiments of the invention. The dynamic graph management module 34 also stores routing information needed to route messages 5 between vertices 2, such as which vertices 2 are stored in the same machine and which vertices 2 are stored in different machines. Finally, the dynamic graph management module 34 is also responsible of partitioning the graph 1 and deciding which partitions 6 are handled by each machine. Note that since the graph 1 is dynamic and its topology may change over time, the dynamic graph management 34 is responsible of modifying the partitioning and the distribution of the resulting partitions accordingly when necessary.

Since the system is capable of processing multiple consistent graph snapshots 23 at the same time, a graph consistency module 35 is included in order to ensure that the multiple snapshots 23 are processed properly. For example, the graph consistency module 35 prevents processing a graph 1 while it is being modified by external changes, and that any graph changes 9 that occur after a processing is initiated do not affect the correctness of said processing.

Graph processing logic module 36 handle the computation of the data mining algorithms in order to provide the updated output 30. Graph processing logic module 36 applies memoization in order to minimize the amount of computations required at each iteration by re-using previous computations whenever possible. This process is supported by a memoization module 37 which saves the inputs and outputs of vertex computation in a space-efficient manner. Inputs typically include input messages and vertex state and topology. Memoization module 37 receives the inputs and outputs of vertex computations from the graph processing logic module 36, and provides the updated memoized states to said graph processing logic module 36 for efficient graph analysis.

According to the described preferred embodiments of the method and system of the invention, real-time analysis of large dynamic graphs is enabled. Computational load is minimized through memoization, reducing both latency and required compute resources. Furthermore, users and code developers can directly apply algorithms already devised for static graph analysis, being the system and method of the invention responsible for dynamically updating the results of the devised algorithm without further modifications from the users.

1. A method of analyzing a dynamic graph through iterative computations at a plurality of vertices, the method comprising, for each vertex and each computation iteration:
i) for a first graph state with a plurality of computation inputs for each vertex, computing a result for each vertex computation;
wherein the method further comprises, for each computation iteration:
ii) for the first graph state, for each vertex computation storing the plurality of computation inputs and the computation result;
iii) for a second graph state with a second plurality of computation inputs:
for each vertex, if the first plurality of computation inputs is the same as the second plurality of computation inputs, updating the computation result by re-using the stored result;
for each vertex, if the first plurality of computation inputs is different from the second plurality of computation inputs, updating the computation result by executing the computation with the second plurality of computation inputs.

2. The method of claim 1, wherein the computation inputs comprise at least one selected from the group consisting of: vertex state, graph topology surrounding the vertex and information received from adjacent vertices.

3. The method of claim 1, wherein the method further comprises distributing vertices in a plurality of partitions, each partition comprising at least one compute state, and the at least one compute state storing computation results of the vertices distributed in the partition.

4. The method of claim 3, wherein each partition handles a limited number of edges between vertices.

5. The method of claim 3 wherein each partition comprises routing information to communicate vertices distributed in different partitions.

6. The method of claim 3, wherein each partition comprises an aggregate state storing a contribution of the vertices of the partition to a global aggregator.

7. The method of claim 3, wherein the vertices belonging to each partition are redistributed over time.

8. The method of claim 3, wherein each partition comprises a plurality of compute states, the plurality of compute state comprising computation results associated to a plurality of algorithms.

9. The method of claim 1, further comprising overlapping a plurality of executions of the algorithm associated to a plurality of changes in the graph, and reconstructing a computation result associated to a given state of the graph by applying the computation results associated to each of the changes whose occurrence precedes the given graph state.

10. The method of claim 9, further comprising storing the results of each computation with a monotonically increasing identifier associated with each change.

11. The method of claim 10, further comprising removing stored computation results and computation inputs associated to fully completed executions of the algorithm.

12. The method of claim 9, further comprising grouping and scheduling graph changes before executing the computations associated to the scheduled changes.

13. The method of claim 1, wherein vertices are communicated through messages.

14. The method of claim 13, wherein vertices which received a message in a previous execution of the algorithm and do not receive said message in a current execution of the algorithm are explicitly notified.

15. The method of claim 1, wherein vertices are communicated through a shared memory.

16. A system of analyzing a dynamic graph through iterative computations at a plurality of vertices, the system comprising graph processing means adapted to, for each vertex and each computation iteration:
i) for a first graph state with a plurality of computation inputs for each vertex, computing a result for each vertex computation;
wherein the system further comprises memoization means that are further adapted to, for each computation iteration:
ii) for the first graph state, for each vertex computation storing the plurality of computation inputs and the computation result;
iii) for a second graph state with a second plurality of computation inputs:
for each vertex, if the first plurality of computation inputs is the same as the second plurality of computation inputs, updating the computation result by re-using the stored result;
for each vertex, if the first plurality of computation inputs is different from the second plurality of computation inputs, updating the computation result by executing the computation with the second plurality of computation inputs at the graph processing means.

17. The system of claim 16, wherein the graph processing means and the memoization means are distributed in a plurality of partitions, each partition comprising at least one compute state, the at least one compute state comprising computation results of a plurality of vertices distributed in the partition.

18. The system of claim 16, further comprising dynamic graph management means adapted to overlap a plurality of executions of the algorithm associated to a plurality of changes in the graph, and wherein the graph processing means are further adapted to reconstruct a computation result associated to a given state of the graph by applying the computation results associated to each of the changes whose occurrence precedes the given graph state.

19. The system of claim 16, further comprising a scheduler adapted to group and schedule graph changes before executing the computations associated to the scheduled changes.

20. A computer program comprising computer program code means adapted to perform the steps of the method according to claim 1 when said program is run on a computer, a digital signal processor, a field-programmable gate array, an application-specific integrated circuit, a micro-processor, a micro-controller, or any other form of programmable hardware.
